(19) United States
(12) Patent Application Publication
(10) Pub. No.: US 2003/0024660 A1
(43) Pub. Date: Feb. 6, 2003

(54) Convertible collapsible barrier

(76) Inventor: Shelley M. Homeyer, Houston, TX (US)

Correspondence Address: TROP PRUNER & HU, PC, 8554 KATY FREEWAY, SUITE 100, HOUSTON, TX, 77024, US

(21) Appl. No.: 10/265,787

(22) Filed: Oct. 7, 2002

Related U.S. Application Data
(63) Continuation-in-part of application No. 09/780,242, filed on Feb. 9, 2001, now Pat. No. 6,474,021.
Application No. 09/780,242 is a continuation-in-part of application No. 09/524,226, filed on Mar. 13, 2000, now Pat. No. 6,185,762.
Application No. 09/524,226 is a continuation of application No. 09/169,412, filed on Oct. 9, 1998, now Pat. No. 6,035,466.

(51) Int. Cl. E06B 3/30

(52) U.S. Cl. 160/377

(57) ABSTRACT

A collapsible barrier having a frame that may be converted from a gate configuration to a bed rail configuration and back again. The barrier also has a flexible cover that is attached to the frame. The frame may include tubes connected by couplings and one or more elastic cord. When the tubes and couplings are disconnected, the barrier folds so that it may be easily stored or transported.

This application a continuation-in-part of application Ser. No. 09/780,242 filed on Feb. 9, 2001, which is a continuation-in-part of application Ser. No. 09/524,226 filed on Mar. 13, 2000 issuing as U.S. Pat. No. 6,185,762 on Feb. 13, 2001, which is a continuation of application Ser. No. 09/169,412 filed on Oct. 9, 1998, which issued as U.S. Pat. No. 6,035,466 on Mar. 14, 2000.

### BACKGROUND

This invention relates generally to child safety devices.

There are many every-day objects that while not dangerous to most adults, pose threats for small children. For example, sharp corners on tables or elsewhere, blind cords, electrical outlets and stairs may all be hazardous to young children. Moreover, when a child is ready to sleep in a bed rather than a crib, the child may fall out of bed and get hurt. To avoid potential accidents due to these dangers, parents and other caretakers may install child safety devices. One type of child safety device is a gate to prevent a child from gaining access to a dangerous area such as a staircase or the kitchen. Another type of child safety device is a bed rail to prevent the child from falling out of bed.

Many safety gates are intended to be permanently or semi-permanently fixed in place. For example, the gate may be permanently fixed at the top and/or bottom of a staircase. Once installed, these types of gates are not easily removed and transported. Other types of gates may not be permanently placed; however, these gates also tend to be cumbersome and difficult to transport.

Although not typically permanently or semi-permanently fixed in place, most bed rails are not designed for easy transport. Thus, parents and caretakers are presented with a problem when they are traveling with small children and they do not have a safety gate or a bed rail that are easy to transport.

For example, parents may visit family members or friends who do not have safety gates in place. Moreover, the host may not have a child-safe bed for the child to sleep in. Thus, the parents may need to bring both a gate and a bed rail on the visit. Because traveling with a small child usually requires transporting other equipment such as a stroller, a car seat and a play yard it is desirable to have a safety gate and a bed rail that are portable.

Thus, there is a need for a collapsible barrier that is easy to transport and that can be converted from a safety gate into a bed rail and back again.

### BRIEF DESCRIPTION OF THE DRAWINGS

FIG. 1 is a front elevational view of one embodiment of the present invention;

FIG. 2 is a front elevational view of the embodiment in FIG. 1 that is adjusted to fit a doorway of a different width than in FIG. 1;

FIG. 3 is an elevated perspective view of the embodiment shown in FIG. 1 that is converted to a bed-rail configuration;

FIG. 4 is a front elevational view of the frame utilized in the embodiment shown in FIG. 1;

FIG. 5 is a side elevational view of the frame of FIG. 4 in the gate configuration;

FIG. 6 is a side elevational view of the frame of FIG. 4 in the bed rail configuration;

FIG. 7 is a front elevational view of the frame utilized in the embodiment shown in FIG. 1 that is partially disassembled;

FIG. 8 is a cross-sectional view generally taken along the vertical plane of the upper left side of the frame in FIG. 4;

FIG. 9 is a partial cross-sectional view generally taken along the vertical plane of the center left side of the frame in FIG. 4;

FIG. 10 is the partial cross-sectional view of FIG. 9 when the frame of FIG. 4 is configured as a bed rail;

FIG. 11 is a perspective view of the coupling depicted in FIGS. 9 and 10;

FIG. 12 is a front elevational view of the embodiment shown in FIG. 4 in a partially collapsed state;

FIG. 13 is a front elevational view of the embodiment shown in FIG. 4 that has been collapsed further; and

FIG. 14 is a front elevational view of the embodiment shown in FIG. 4 that is completely collapsed.

### DETAILED DESCRIPTION

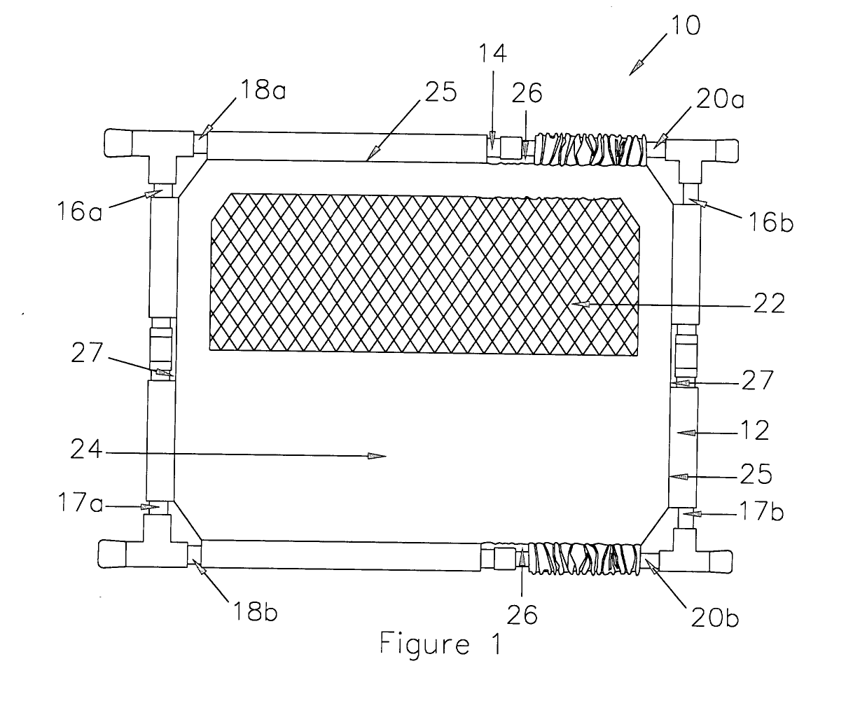

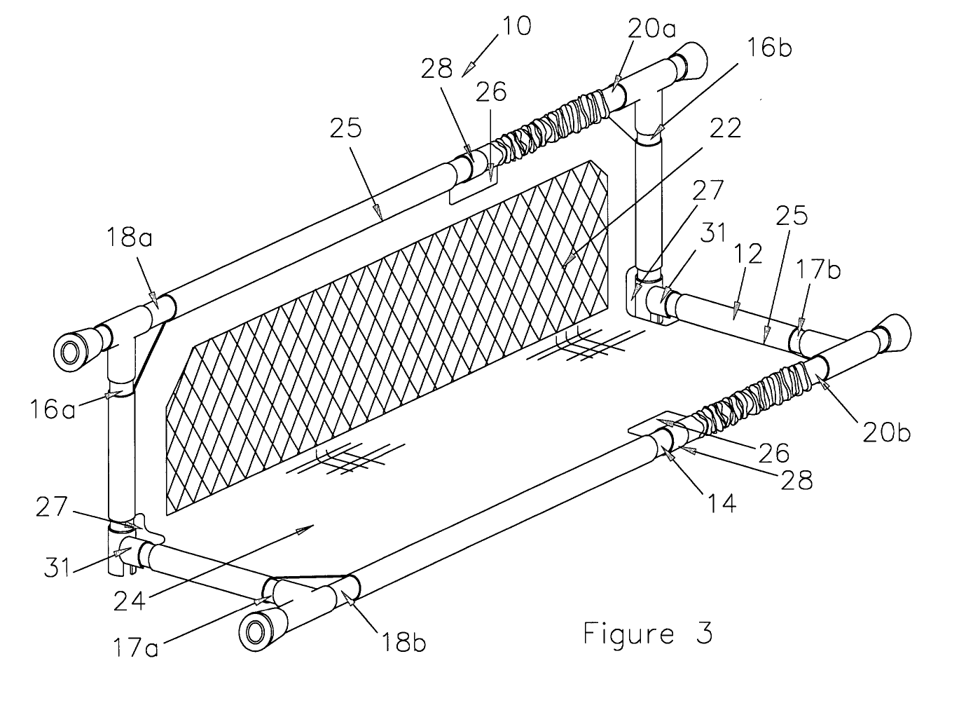

Referring to the drawings wherein like reference characters are used for like parts throughout the several views, a convertible collapsible barrier 10, shown in FIG. 1, may act as a partition to block stairs and other areas that may be dangerous for children or animals to be without close supervision. Additionally, the barrier 10 may serve as a bed rail as shown in FIG. 3, to prevent children or other persons from falling out of bed. The barrier 10 includes a collapsible frame 14 and a flexible cover 12.

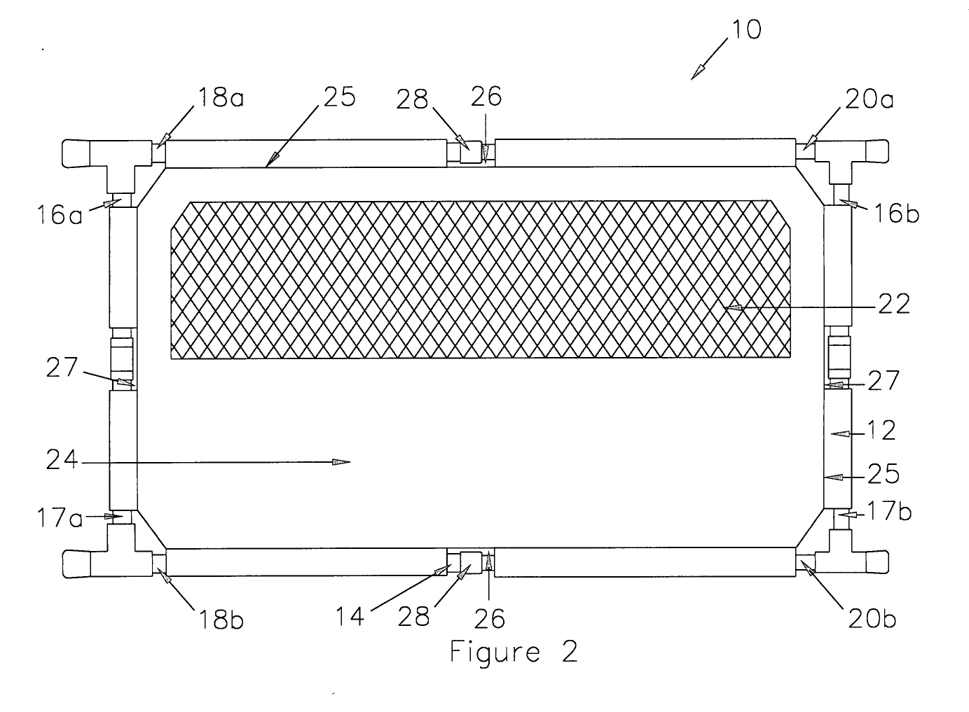

In some embodiments, the cover 12 may envelop the frame 14 as shown in FIG. 1. The cover 12 may have loose folds that unfold to cover the frame 14 at a greater width and refold to cover the frame 14 at a lesser width. For example, when the frame 14 is fully extended, as shown in FIG. 2, the cover 12 may be completely unfolded and taut. However, when the frame 14 is not fully extended, as in FIG. 1, the cover 12 may be slack, having gathers or loose folds.

Moreover, in some embodiments the cover 12 may have a central see-through portion 22 and a folded portion 24 that borders the see-through portion 22. The border formed by the folded portion 24 may be symmetrical or asymmetrical. For example, in some embodiments the cover 12 may be largely comprised of the see-through portion 22 with the folded portion 24 creating a relatively thin border that is equal on all sides. In other embodiments, the cover 12 may be comprised of a relatively smaller see-through portion 22 with the folded portion 24 creating a relatively thick border on one side and a relatively thin border on the remaining sides. However, the proportions and positions of the see-through portion 22 and the folded portion 24 are not limited to the embodiments presented herein. The see-through portion 22 may be a meshed fabric, netting or the like, whereas the folded portion 24 may be a durable fabric such as canvas, nylon or the like.

The folded portion 24 is configured so that it folds over the frame 14 to encircle tubes 16, 17, 18 and 20. The folded portion 24 may be secured to the central portion 22 or to itself, for example, by a stitched seam 25. However, the folded portion 24 may be secured by any conventional means. Moreover, the folded portion 24 may be permanently secured or removably secured to itself or to the central portion 22. Advantageously, removable attachment may make the cover 12 easy to clean. Additionally, in some embodiments, the folded portion 24 that encircles the tubes 16 and 17 may have cut outs 27. Likewise, the folded portion 24 that encircles tubes 18 and 20 may have cutouts 26. The cutouts 26 and 27 allow the user to access the frame 14 for manipulation.

As shown in FIG. 2, the barrier 10 is adjustable to accommodate doorways and stairways of various widths. Generally, the tubes 18 and 20 are engaged so that tube 20 telescopically moves or slides inside tube 18 to make the barrier 10 more or less wide. A locking mechanism 28, such as a twist lock, may be used to secure the tubes 20 at a desired length and prevent the tubes 20 from moving. The locking mechanism 28 may be of the type commonly found on extendable paintbrushes and on poles used for cleaning swimming pools, although the scope of the invention is not limited in this respect.

As shown in FIG. 3, the barrier 10 may be converted from the gate configuration to a bed-rail configuration. Generally, the tubes 17 are disengaged from couplings 31 at one position and re-engaged with the same couplings 31 at a different position, as is explained below. Thus, when in the bed-rail configuration and when in use, a portion of the barrier 10 may fit under a mattress such that another portion fits snuggly against the mattress and is generally perpendicular to the horizontal plane of the mattress. For example, when in the bed-rail configuration, tubes 17, 18b and 20b may fit under the mattress so that the edge of the mattress abuts tubes 16. Moreover, tubes 16, 18a and 20a are generally perpendicular to the horizontal surface of the mattress. As a result, the barrier 10 will prevent a child from rolling off of the mattress onto the floor.

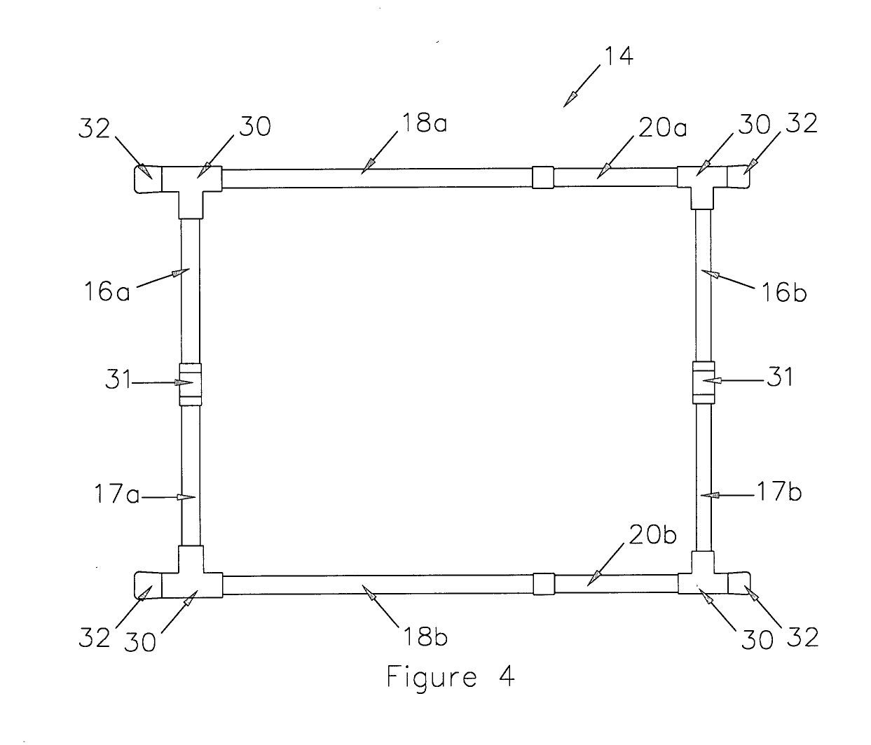

As shown in FIG. 4, in one embodiment, the frame 14 may be formed from relatively rigid hollow tubes 16, 17, 18 and 20. Couplings 30, such as hollow tubing-tees, may connect tubes 16a and 16b to tubes 18a and 20a respectively. The same couplings 30 may connect tubes 17a and 17b to tubes 18b and 20b respectively. Couplings 31, which may also be hollow tubing-tees connect tubes 16 and 17. Tubes 18 and 20 are engaged as previously described. When in the gate configuration tubes 16 and 17 are vertical and tubes 18 and 20 are horizontal. However, when in the bed rail configuration tubes 16 are vertical and tubes 17, 18 and 20 are horizontal with tubes 16 and 17 forming an angle such as a right angle.

One end of the tubes 16, 17, 18 and 20 are removably telescoped within the interior of the couplings 30. The connections between couplings 30 and the tubes 16, 17, 18 and 20 are all resilient so that the barrier 10 is substantially self-assembled. The couplings 30 may also be connected to feet 32. The feet 32 apply pressure to a vertical surface, such as the walls of a doorway or stairway, to keep the barrier 10 in place. The feet 32 may be rubber or plastic tips or the like.

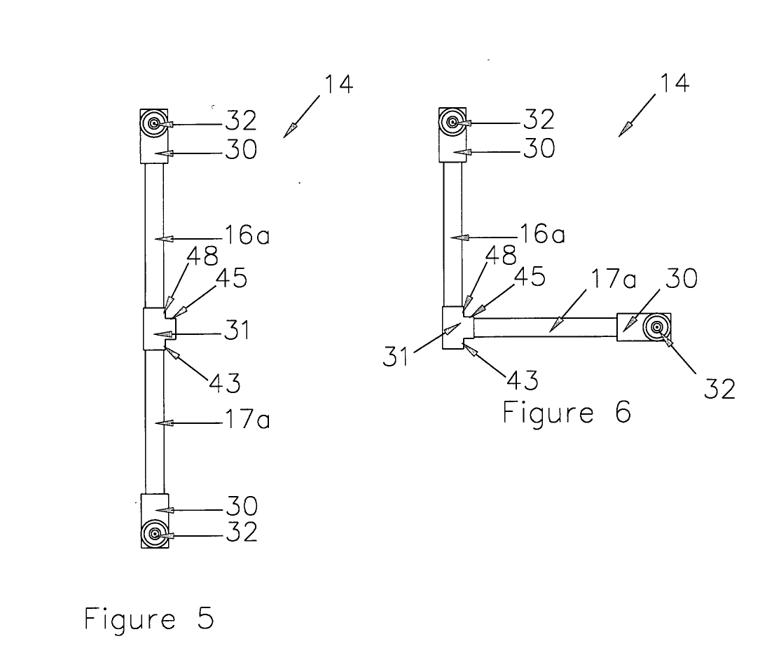

Referring to FIGS. 5 and 6, the ends of the tubes 16 and 17 that are not telescoped within the interior of couplings 30 are telescoped within the interior of couplings 31. Additionally, the tubes 17 may be removably telescoped within the interior of couplings 31 at two different positions. In contrast, the tubes 16 may be either removably or permanently telescoped within the interior of couplings 31 at one position.

If removable, tubes 16 may be resiliently coupled to tubes 17 through couplings 31. In some embodiments of the present invention, when the frame 14 is in the gate configuration the tubes 17 are positioned within sidearms 43 of the couplings 31 and the tubes 16 are positioned within sidearms 48 of the couplings 31 so that the tubes 16 and 17 form a straight line. However, the tubes 17 may be disengaged from sidearm 43 and may be resiliently re-engaged with sidearm 45 so that the tubes 16 and 17 are generally perpendicular to each other, as shown in FIG. 6. In this way, the barrier 10 may be converted from the gate configuration to the bed-rail configuration. Moreover, the tubes 17 may simply be disengaged from sidearm 45 and resiliently re-engaged with sidearm 43 to revert to the gate configuration. Thus, the barrier 10 may be easily converted or transformed from a safety gate to a bed rail and back again. The connections between couplings 31 and the tubes 17 are resilient to facilitate conversion between the gate and bed-rail configurations.

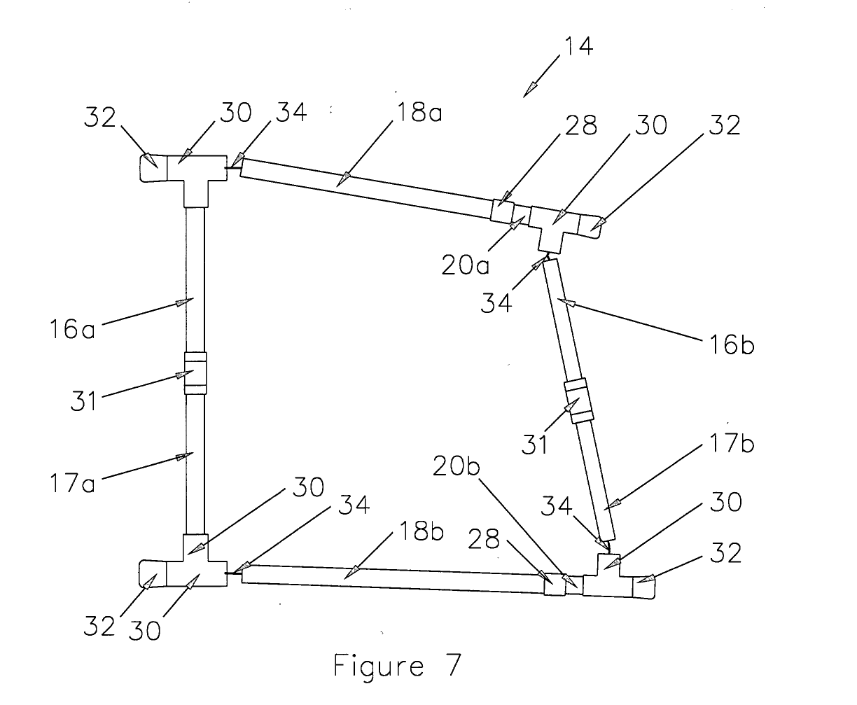

Referring to FIG. 7, the frame 14 has been partially disassembled to show some resilient connections between the couplings 30 and the tubes 16, 17 and 18. In this illustration, tubes 18a and 18b have been removed from the couplings 30. Moreover the tubes 16b and 17b have been removed from the couplings 30. The tubes 16a, 17a, 20a and 20b are removable from the couplings 30 in a like manner.

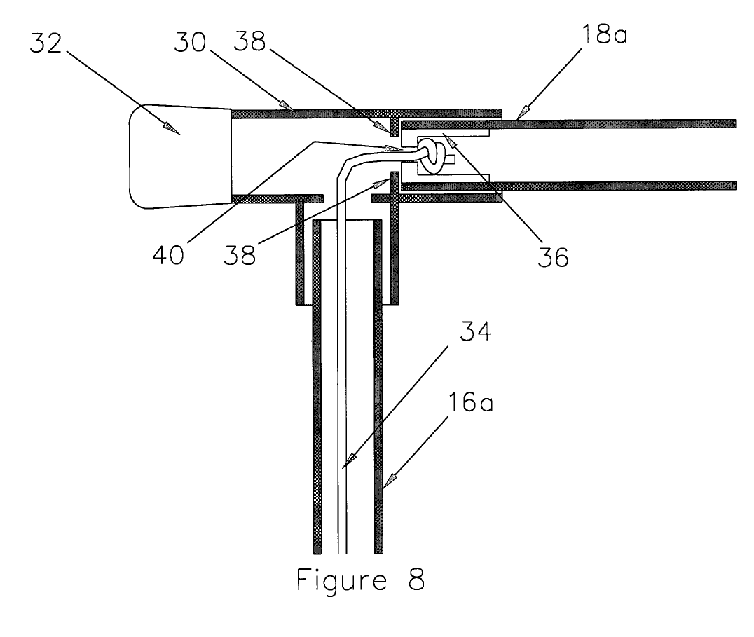

In one embodiment, elastic cords 34 extend through the tubes 16, 17, 18 and 20 and the couplings 30 and 31. For example, an elastic cord 34 may originate in tube 18a, as shown in FIG. 8. The cord 34 then may pass through a coupling 30 and the tube 16a, also shown in FIG. 8. Lastly, the cord 34 may pass through a coupling 31, the tube 17a and another coupling 30 to terminate in the tube 18b (not shown).

Another elastic cord 34 may mirror the first elastic cord 34. That is, another elastic cord 34 may originate in tube 20a, pass through a coupling 30, the tube 16b, a coupling 31, the tube 17b and another coupling 30 to terminate in tube 20b (not shown).

The elastic cords 34 are anchored within the tubes 18 and 20 by plugs 36. Plug 36 is shown in FIG. 8, however, all four corners of the barrier 10 may share a similar configuration. The plug 36 may be fitted inside the tube 18a, as shown in FIG. 8. The plug 36 may be permanently attached within the tube 18a by glue, rivets or the like so that the plug 36 will not come loose when the cord 34 is under tension. In this embodiment, the elastic cord 34 is knotted to prevent it from exiting an opening 40 in the plug 36. However, any other means may be used to keep the elastic cord 34 from pulling through the opening 40 of the plug 36.

Stops 38 within the coupling 30 prevent the tube 18a from being pulled through the coupling 30 by the elastic cord 34. Stops 38 may be rivets molded plastic, or the like.

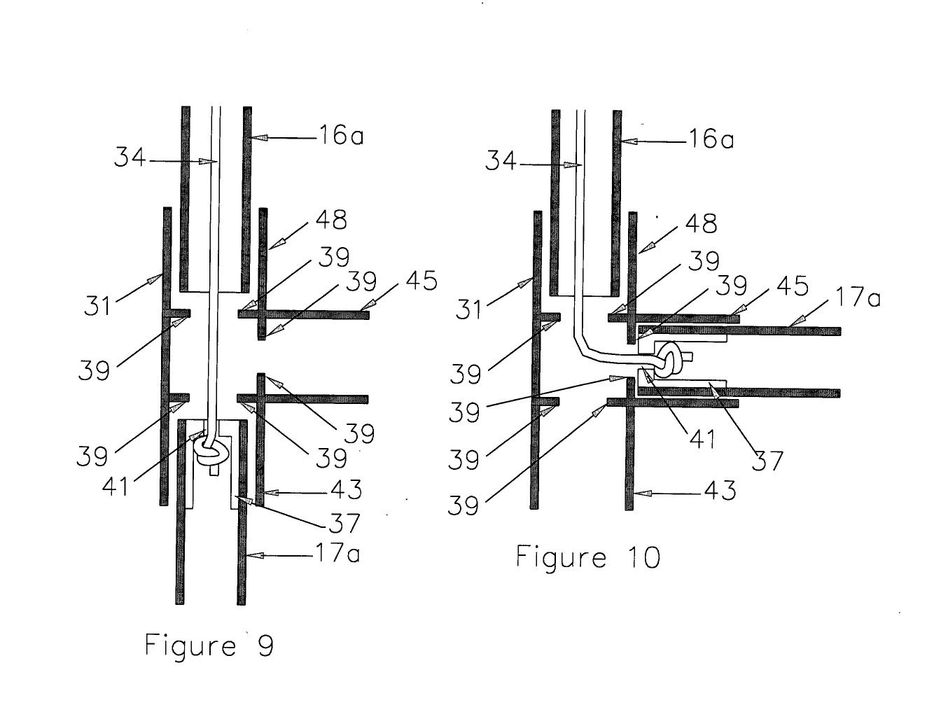

In another embodiment, the elastic cord 34 may originate in tube 18a, as shown in FIG. 8, then pass through a coupling 31 to terminate in the tube 17a, as shown in FIGS. 9 and 10. Another elastic cord 34 may be similarly situated within the tube 18b, the coupling 31 and the tube 17b (not shown). As shown in FIGS. 9 and 10, the cords 34 may be anchored within tubes 17 by a plug 37. The plugs 37 may be the same as or similar to plugs 36. Further, the plugs 37 may be situated within the tubes 17 and permanently attached therein with glue or the like. In this way, the plugs 37 will not come loose when the cords 34 are under tension. The cords 34 may be knotted or otherwise prevented from pulling through an aperture 41 in the plugs 37, although the scope of the invention is not limited in this respect.

Stops 39 within the couplings 31 prevent the tubes 17 from being pulled through the couplings 31 by the cord 34. The stops 39 may be molded plastic, although the scope of the invention is not limited in this respect.

In this embodiment, an additional elastic cord 34 may extend through the tube 17a, coupling 30 and tubes 18b to make resilient connections (not shown). The same resilient connection may be made through tube 17b, coupling 30 and tube 20b (not shown). The connections may be similar to that described with reference to FIG. 8. For example, the elastic cords 34 may originate in tubes 18b and 20b and pass through couplings 30. However, the cords 34 terminate in tubes 17. As with the other resilient connections, plugs may be utilized to retain the cords within the tubes 17, 18b and 20b. Likewise, stops 38 may be utilized to prevent the tubes 17, 18b and 20b from being pulled through the couplings 30.

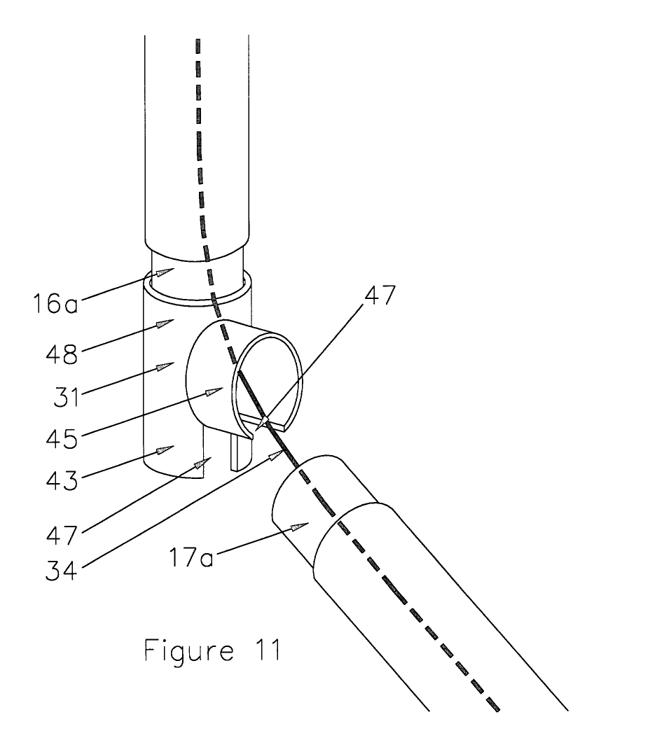

The tubes 17 may be removably telescopically coupled with both sidearm 43 and sidearm 45 of couplings 31, as shown in FIGS. 9 and 10. In embodiments of the present invention, to disengage the tubes 17 from sidearm 43 and resiliently re-engage the tube 17 with sidearm 45 and vice versa, the cord 34 may pass through a channel 47 in the couplings 31, as shown in FIG. 11. For example, when tube 17a is removed from sidearm 43 it is resiliently connected to the frame 14 via the cord 34. Thus, when the cord 34 passes through the channel 47 towards sidearm 45, the tube 17a recoils into the sidearm 45. Accordingly, when tubes 17a and 17b are removably telescopically inserted in sidearms 43, the barrier 10 is in the gate configuration. However, when the tubes 17a and 17b are removably telescopically inserted in sidearms 45, the barrier 10 is in the bed-rail configuration.

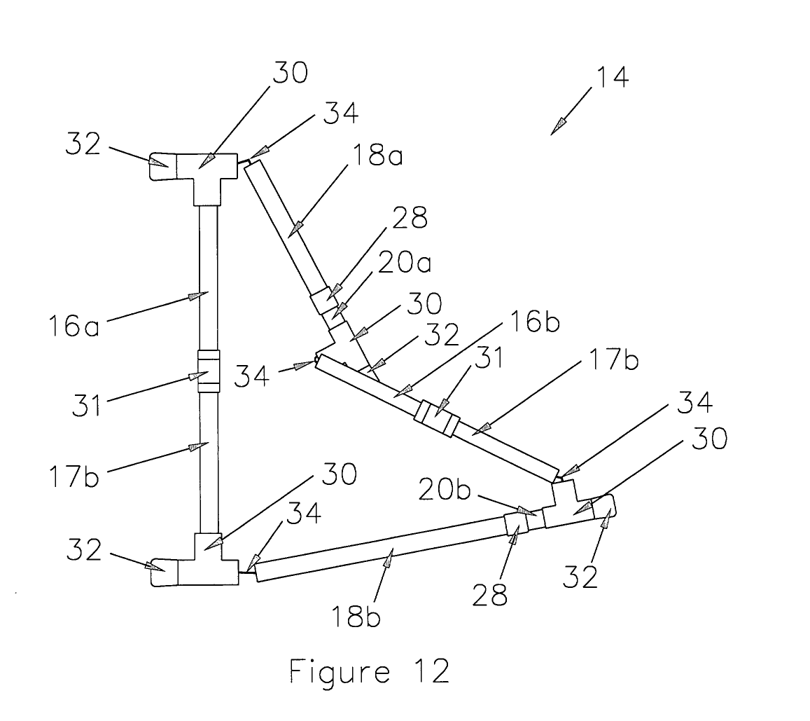

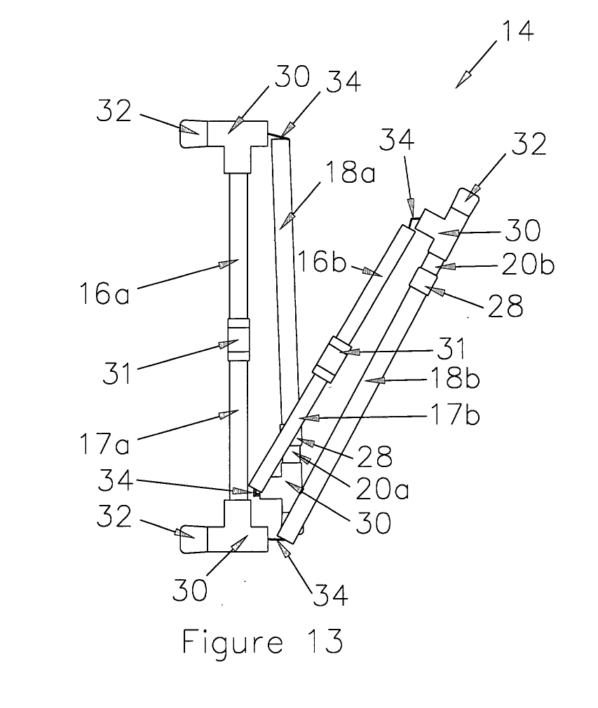

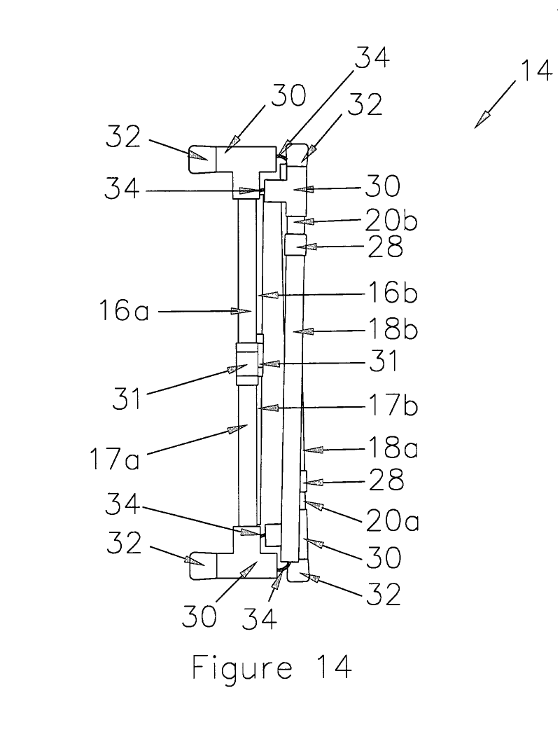

The frame 14 may transition between the relatively rigid state shown in FIG. 4 to a collapsed state shown in FIGS. 12 through 14. The transition between the relatively rigid state and the collapsed state is aided by the elastic cords 34. Generally, disconnecting a couplings 30 and a tube 16, 17, 18 or 20 initiates the transition between the relatively rigid state and the collapsed state. As shown in FIGS. 12 and 13 as the barrier 10 collapses the remaining tubes 16, 17, 18 and 20 may disconnect from the couplings 30 so that the frame 14, hence the barrier 10, folds up upon itself. Ultimately, the frame 14 completely collapses as shown in FIG. 14 so that the barrier 10 may be easily stored and/or transported.

When ready for use, the steps above may be reversed to achieve the relatively rigid state shown in FIG. 4. That is, by giving the barrier 10 a little shake, the tubes 16, 17, 18 and 20, assisted by the cords 34, will removably insert into the couplings 30. As a result, the barrier 10 is quickly assembled and may be adjusted to fit into a particular opening such as a doorway or stairway. Alternately, the barrier 10 may be configured as a bed rail, which may also be adjusted to various lengths.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A collapsible barrier comprising:
a collapsible frame including at least two resiliently coupled relatively rigid tubes, said tubes coupled by a relatively resilient connector such that said tubes may be selectively relatively rigidly coupled to one another in a first way, selectively relatively rigidly coupled to one another in a second way different from said first way, selectively relatively resiliently coupled to one another through said resilient connector when the relatively rigid coupling of the first way is released and selectively relatively resiliently coupled to one another through said resilient connector when the relatively rigid coupling of the second way is released, said frame defining a rectangular partition when said two resiliently coupled tubes are relatively rigidly coupled in the first way and said frame defining an angled barrier when said two resiliently coupled tubes are relatively rigidly coupled in the second way; and
a flexible cover adapted to cover said frame.

2. The barrier of claim 1 further including a third relatively rigid tube resiliently coupled to the first of said at least two resiliently coupled tubes through a second relatively resilient connector such that said first tube and said third tube form a third selective relatively rigid coupling to one another and a third selective relatively resilient coupling to one another through said second connector when said third relatively rigid coupling is released, said third tube being engaged with a fourth relatively rigid tube such that said fourth tube is slidable within said third tube, said frame defining either a rectangular partition or an angled barrier when said first tube and said third tube are relatively rigidly coupled.

3. The barrier of claim 2 further including a fifth and a sixth resiliently coupled relatively rigid resiliently coupled tubes, said fifth and sixth tubes coupled by a third relatively resilient connector such that said fifth tube and said sixth tube may be selectively relatively rigidly coupled to one another in a first way, selectively relatively rigidly coupled to one another in a second way different from said first way, selectively relatively resiliently coupled to one another through said third resilient connector when the relatively rigid coupling of the first way is released and selectively relatively resiliently coupled to one another through said third resilient connector when the relatively rigid coupling of the second way is released, said frame defining a rectangular partition when said fifth and said sixth resiliently coupled relatively rigid tubes are relatively rigidly coupled in the first way and said frame defining an angled barrier when said fifth and said sixth resiliently coupled relatively rigid tubes are relatively rigidly coupled in the second way.

4. The barrier of claim 3 wherein said fifth relatively rigid tube is resiliently coupled to said fourth relatively rigid tube through a fourth relatively resilient connector such that said fifth tube and said fourth tube form a sixth selective relatively rigid coupling to one another and a sixth selective relatively resilient coupling to one another through said fourth connector when said sixth relatively rigid coupling is released, said frame defining either a rectangular partition or an angled barrier when said fourth tube and said fifth tube are relatively rigidly coupled.

5. The barrier of claim 4 further including a seventh relatively rigid tube resiliently coupled to the second of said at least two resiliently coupled tubes through a fifth relatively resilient connector such that said second tube and said seventh tube form a seventh selective relatively rigid coupling to one another and a seventh selective relatively resilient coupling to one another through said fifth connector when said seventh relatively rigid coupling is released, said seventh tube being engaged with an eighth relatively rigid tube such that said eighth tube is slidable within said seventh tube, said frame either defining a rectangular partition or an angled barrier when said second and said seventh resiliently coupled tubes are relatively rigidly coupled.

6. The barrier of claim 5 wherein said sixth relatively rigid tube is resiliently coupled to said eighth relatively rigid tube through a sixth relatively resilient connector such that said sixth tube and said eighth tube form an eighth selective relatively rigid coupling to one another and an eighth selective relatively resilient coupling to one another through said sixth connector when said eighth relatively rigid coupling is released, said frame defining either a rectangular partition or an angled barrier when said sixth tube and said eighth tube are relatively rigidly coupled.

7. The barrier of claim 6 wherein each of said connectors is a tee-shaped connector.

8. The barrier of claim 7 further including a foot coupled to each of said second, said fourth, said fifth and said sixth connector.

9. The barrier of claim 2 wherein said frame is adjustable for width by slidably moving said fourth tube within said third tube.

10. The barrier of claim 9 further including a locking mechanism adapted to prevent said fourth tube from slidably moving within said third tube.

11. The barrier of claim 1 wherein said cover has a central see-through portion and a folded portion adapted to encircle said frame.

12. A method comprising:
resiliently coupling at least two relatively rigid tubes through a relatively resilient connector such that said at least two relatively rigid tubes may be selectively relatively rigidly coupled to one another in a first way, selectively relatively rigidly coupled to one another in a second way different from said first way, selectively relatively resiliently coupled through said resilient connector when the relatively rigid coupling of the first way is released and selectively relatively resiliently coupled through said resilient connector when the relatively rigid coupling of the second way is released;
defining a rectangular frame when said at least two resiliently coupled tubes are relatively rigidly coupled in the first way;
defining an angled frame when said at least two resiliently coupled tubes are relatively rigidly coupled in the second way; and
covering said frame with a flexible cover.

13. The method of claim 12 further including resiliently coupling a third relatively rigid tube to the first of said at least two resiliently coupled tubes through a second relatively resilient connector such that said first tube and said third tube form a third selective relatively rigid coupling to one another and a third selective relatively resilient coupling to one another through said second connector when said third relatively rigid coupling is released, engaging said third tube with a fourth relatively rigid tube such that said fourth tube is slidable within said third tube, and defining either a rectangular frame or an angled frame when said first tube and said third tube are relatively rigidly coupled.

14. The method of claim 13 further including resiliently coupling a fifth relatively rigid tube and a sixth relatively rigid tube, said fifth and sixth relatively rigid tubes coupled by a third relatively resilient connector such that said fifth tube and said sixth tube may be selectively relatively rigidly coupled to one another in a first way, selectively relatively rigidly coupled to one another in a second way different from said first way, selectively relatively resiliently coupled through said third resilient connector when the relatively rigid coupling of the first way is released and selectively relatively resiliently coupled through said third resilient connector when the relatively rigid coupling of the second way is released, and defining a rectangular frame when said fifth and said sixth resiliently coupled relatively rigid tubes are relatively rigidly coupled in the first way, and defining an angled frame when said fifth and said sixth resiliently coupled relatively rigid tubes are relatively rigidly coupled in the second way.

15. The method of claim 14 further including resiliently coupling said fifth relatively rigid tube to said fourth relatively rigid tube through a fourth relatively resilient connector such that said fifth tube and said fourth tube form a sixth selective relatively rigid coupling to one another and a sixth selective relatively resilient coupling to one another through said fourth connector when said sixth relatively rigid coupling is released, and defining either a rectangular frame or an angled frame when said fourth tube and said fifth tube are relatively rigidly coupled.

16. The method of claim 15 further including resiliently coupling a seventh relatively rigid tube to the second of said at least two resiliently coupled tubes through a fifth relatively resilient connector such that said second tube and said seventh tube form a seventh selective relatively rigid coupling to one another and a seventh selective relatively resilient coupling to one another through said fifth connector when said seventh relatively rigid coupling is released, engaging said seventh tube with an eighth relatively rigid tube such that said eighth tube is slidable within said seventh tube, and defining a rectangular frame or an angled frame when said second and said seventh resiliently coupled tubes are relatively rigidly coupled.

17. The method of claim 16 further including resiliently coupling said sixth relatively rigid tube to said eighth relatively rigid tube through a sixth relatively resilient connector such that said sixth tube and said eighth tube form an eighth selective relatively rigid coupling to one another and an eighth selective relatively resilient coupling to one another through said sixth connector when said eighth relatively rigid coupling is released, and defining either a rectangular frame or an angled frame when said sixth tube and said eighth tube are relatively rigidly coupled.

18. The method of claim 17 further including coupling a foot to each of said second, said fourth, said fifth and said sixth connector.

19. The method of claim 13 further including locking said fourth tube with a locking mechanism to prevent said fourth tube from sliding within said third tube.

20. The method of claim 12 wherein covering said frame includes covering said frame with a cover that has a central see-through portion and a folded portion adapted to encircle said frame.
